(19) United States
(12) Patent Application Publication
(10) Pub. No.: US 2016/0104924 A1
(43) Pub. Date: Apr. 14, 2016

(54) Secondary Battery System

(71) Applicant: Hitachi, Ltd., Tokyo (JP)

(72) Inventors: Takashi KAMIJOH, Tokyo (JP); Kenji TAKEDA, Tokyo (JP); Kohei HONKURA, Tokyo (JP); Yuuji NAGASHIMA, Tokyo (JP)

(21) Appl. No.: 14/878,394

(22) Filed: Oct. 8, 2015

(30) Foreign Application Priority Data
Oct. 10, 2014 (JP) 2014-208515

(51) Int. Cl. H01M 10/635; H01M 10/0525; H01M 10/613

(52) U.S. Cl. CPC H01M 10/635; H01M 10/613; H01M 10/0525

(57) ABSTRACT

Provided is a secondary battery system includes: a secondary battery; a temperature control device for cooling the secondary battery; a battery management unit; and a temperature detector for detecting a temperature of the secondary battery, in which the battery management unit includes an SOC calculating part for calculating a state of charge (an SOC) of the secondary battery and a potential estimating part for estimating potentials of the anode and the cathode of the secondary battery, and in which the temperature control device is operated when an operating condition is set corresponding to the potentials of the anode and the cathode is met. Thus, it is made achievable to satisfy an elongated serve life of the battery and a cost reduction of a temperature control operation at the same time.

### CLAIM OF PRIORITY

The present application claims priority from Japanese Patent application serial No. 2014-208515, filed on Oct. 10, 2014, the content of which is hereby incorporated by reference into this application.

### BACKGROUND OF THE INVENTION

1. Field of the Invention

The present invention relates to a secondary battery system.

2. Description of Related Art

In recent years, there have been energetically developed electrical storage systems using lithium-ion secondary batteries. Under operation of an electrical storage system (hereinafter also referred to as “a secondary battery system”), a lithium-ion secondary battery involves heat generation due to its internal resistance components. Since increases in battery temperature due to heat generation make a cause of battery deterioration, the electrical storage system needs to be equipped with a temperature control device such as an air conditioner or a fan. However, operating such a temperature control device involves a power consumption, giving rise to an operational loss of the electrical storage system. Therefore, it is required to suppress an excessive cooling and reduce the operational loss. It is known that deterioration of the lithium-ion secondary battery depends on not only the battery temperature but also the internal state of the battery. The internal state of the battery has a relation to a state of charge (hereinafter, referred to as “SOC”).

In terms of this characteristic, Japanese Unexamined Patent Application Publication No. 2008-016230 (Patent Document 1) describes an electrical storage system in which a temperature control device is operated when a battery temperature exceeds a threshold for temperatures corresponding to estimated SOCs.

### SUMMARY OF THE INVENTION

In order to solve the above-described problem, a secondary battery system according to the present invention includes: a secondary battery; a temperature control device for cooling the secondary battery; a battery management unit; and a temperature detector for detecting a temperature of the secondary battery, in which the battery management unit includes an SOC calculating part for calculating a state of charge (an SOC) of the secondary battery and a potential estimating part for estimating potentials of the anode and the cathode of the secondary battery, and in which the temperature control device is operated when an operating condition set corresponding to the potentials of the anode and the cathode is met.

According to the present invention, it is made achievable to satisfy an elongated serve life of the battery and a cost reduction of a temperature control operation at the same time. Problems, constitution and effects of the present invention other than the above-described ones will become apparent by the following description of the embodiment.

### BRIEF DESCRIPTION OF THE DRAWINGS

FIG. 1 is a view showing a secondary battery system in an embodiment of the present invention including a temperature control device and showing an operation of the temperature control device;

FIG. 2 is a schematic view showing an internal structure of a lithium-ion secondary battery in an embodiment of the present invention;

FIG. 3 is a characteristic chart showing relationships between an SOC and potentials of an anode and a cathode of an initial state of a battery in an embodiment of the present invention;

FIG. 4 is a characteristic chart showing relationships between the SOC and the potentials of the anode and the cathode of an after-use state of the battery in the embodiment of the present invention;

FIG. 5 is a characteristic chart in which relationships between the SOC and the potentials of the anode and the cathode are compared between the initial state and the after-use state of the battery in the embodiment of the present invention;

FIG. 6 is a characteristic chart showing relationships between the SOC and a battery deterioration in the embodiment of the present invention;

FIG. 7 is a characteristic chart showing a relationship between a battery temperature for operating a temperature control device and an anode potential in an embodiment of the present invention;

FIG. 8 is a chart showing a relationship between the battery temperature for operating the temperature control device and a cathode potential in the embodiment of the present invention;

FIG. 9 is a schematic view showing a structure of a lithium-ion secondary battery in an embodiment of the present invention;

FIG. 10 is a block diagram of an electrical storage system to which a temperature control function in an embodiment of the present invention is applied;

FIG. 11 is a flowchart showing a temperature control process in a first embodiment of the present invention; and

FIG. 12 is a flowchart showing a sub-process of the temperature control process in the first embodiment of the present invention.

### DETAILED DESCRIPTION OF THE PREFERRED EMBODIMENT

Hereinbelow, an embodiment of the present invention will be described with reference to the accompanying drawings and the like. The following description is intended only to show concrete examples of contents of the present invention, and without being limited to the description, the present invention may be changed and modified in various ways by those skilled in the art within a scope of the technical concept herein disclosed. In addition, throughout all the drawings for explaining the present invention, component members having the same function are designated by the same reference signs, where their repetitive description may be omitted.

Battery deterioration due to high temperature depends on an internal state of the battery, i.e., potentials of an anode and a cathode constituting the battery. The technique described in Patent Document 1 is characterized in that the temperature control device is operated in linkage with the SOC. However, as the battery involves progresses of various reactions inside the battery while the battery continued to be used, the potentials of the anode and the cathode of the battery under an unchanged SOC vary depending on an internal state of the battery. In Patent Document 1, a temperature at which the temperature control device is to be operated is determined by a temperature threshold corresponding to an SOC that has previously been stored in the system. Therefore, with the technique described in Patent Document 1, it is difficult to fulfill the temperature control in response to the internal state of the battery, and also difficult to fulfill a proper cooling control that satisfies both an elongated serve life of the battery and a cost reduction of a cooling operation at the same time.

An object of the present invention is to satisfy the elongated serve life of the battery and the cost reduction of the cooling operation at the same time.

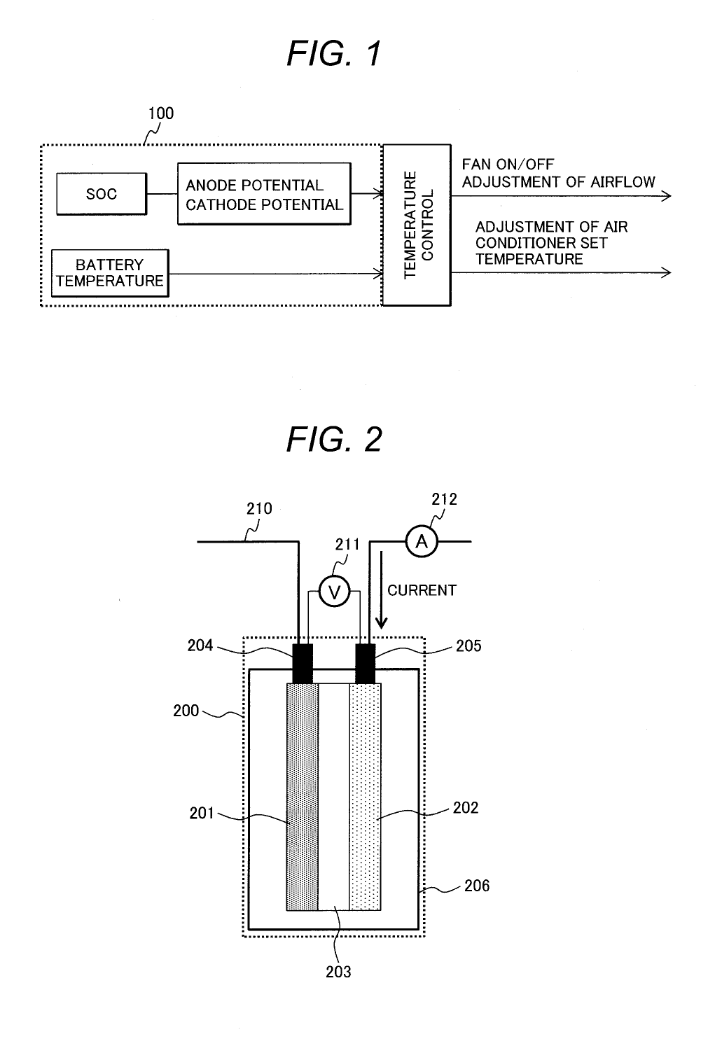

FIG. 1 is a view showing a secondary battery system in an embodiment of the present invention including a temperature control device and showing an operation of the temperature control device. The secondary battery system according to FIG. 1 includes a lithium-ion secondary battery, a temperature control device for cooling the lithium-ion secondary battery, a battery management unit, and a temperature detector for detecting a temperature of the lithium-ion secondary battery.

The battery management unit 100 has a function of estimating an SOC of the lithium-ion secondary battery and calculating an anode potential and a cathode potential corresponding to each SOC. This invention includes a mechanism for operating the temperature control function based on an anode potential and a cathode potential which are calculated and a battery temperature which is detected to operate a fan, adjust airflow of the fan or adjust a set temperature of an air-conditioning equipment. Therefore, the battery management unit includes an SOC calculating part for calculating the SOC of the battery, a potential estimating part for estimating the anode potential and the cathode potential, and a restriction temperature determining part for determining a temperature for operating a temperature control based on an internal state of the battery.

Steps of the fan airflow level, although not particularly limited, may be set switchable among three steps of large, medium and small levels. The control method for the air-conditioner set temperature, although not particularly limited, may be such that, for example, setting a standard temperature to 28° C. and changing over the set temperature in units of 1° C. The constitution of this invention will be described in detail hereinbelow.

First, the internal structure of the lithium-ion secondary battery to be mounted on an electrical storage system (hereinafter also referred to as “a storage system”) will be described. FIG. 2 shows a schematic view of an internal structure of a lithium-ion secondary battery in one embodiment of the present invention. In the lithium-ion secondary battery 200, electrodes and the like including an anode 201, a separator 203 and a cathode 202 are installed within a battery casing 206 to make up the battery.

The anode 201 and the cathode 202 are placed apart from each other with the electrolyte-containing separator 203 interposed therebetween. Thus, there is no electron conductivity but ionic conductivity between the anode 201 and the cathode 202.

As a current flows from the anode 201 to the cathode 202 as shown in FIG. 2, there occurs progress of a reaction that lithium ions are desorbed from active materials in the cathode 202 and the lithium ions are inserted into active materials in the anode 201.

The electrodes and the like are structured by alternately piling up the anode 201, the separator 203, the cathode 202 and the separator 203 and winding these up, or by alternately piling up the anode 201, the separator 203, the cathode 202 and the separator 203 into stacked layers. The battery is formed into such shapes as cylindrical type, flat-elliptical type, and rectangular type for cases where the electrodes and the like are wound up, and the battery is formed into such shapes as rectangular type and laminate type for cases where the electrodes and the like are structured as stacked layers, where any one of those shapes may be selected.

An anode terminal 204 and a cathode terminal 205 are in electrical conduction with the anode 201 and the cathode 202, respectively, so that the lithium-ion secondary battery 200 is charged and discharged from an external circuit via the anode terminal 204, the cathode terminal 205 and an electronic circuit 210. A voltage sensor 211 is connected to the anode terminal 204 and the cathode terminal 205 while a current sensor 212 is incorporated in the electronic circuit 210, so that a current value flowing through the lithium-ion secondary battery 200 as well as a voltage difference between the anode and the cathode are detected, the voltage difference being a battery voltage.

Next, a function of estimating the SOC of the lithium-ion secondary battery 200 and calculating anode potential and cathode potential corresponding to each SOC will be described. As to the SOC estimation method, for example, an SOC is estimated by using a result of cumulative charging/discharging capacity since a detection point calculated from a battery voltage detected by the voltage sensor 211 and a current value detected by the current sensor 212 at one time point.

Calculation of an anode potential and a cathode potential corresponding to each SOC is enabled by incorporating a relationship between the individual SOCs and the anode/cathode potentials into the battery management unit 100. The relationship between the SOCs and the anode/cathode potentials is calculated by splitting a characteristic chart of electrode potentials corresponding to the individual SOCs into a characteristic chart of anode potentials corresponding to the individual SOCs and a characteristic chart of cathode potentials corresponding to the individual SOCs.

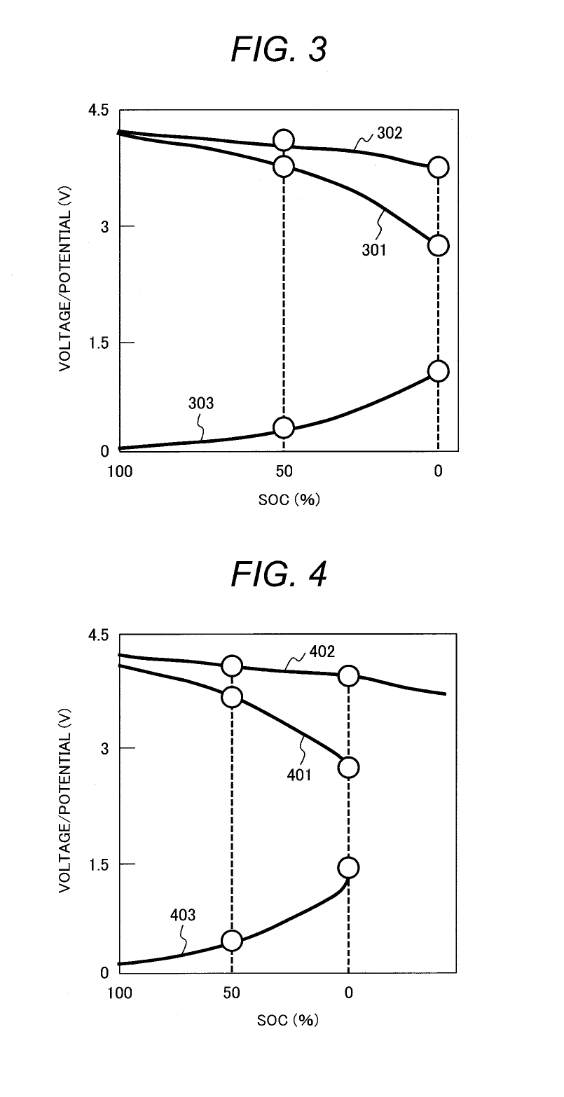

FIG. 3 shows an example of characteristic charts showing the relationships between SOCs and anode/cathode potentials in the initial battery. The horizontal axis represents SOC and the vertical axis represents voltage or electrode potential. An initial SOC curve 301 is a curve showing a relationship between the SOC and the battery voltage in the initial stage. An initial anode SOC curve 302 and an initial cathode SOC curve 303 are curves showing relationships between the SOC and the anode/cathode potentials, respectively, in the initial stage. Since the battery voltage corresponds to a difference between the anode potential and the cathode potential, a result of subtracting the initial cathode SOC curve 303 from the initial anode SOC curve 302 corresponds to the initial SOC curve 301.

Detecting current values and battery voltages in execution of discharging from an SOC of 100% by using a fine current makes it possible to obtain a characteristic curve of the battery voltage approximate to an equilibrium. Applying differential analysis to the result, as is a known technique, allows a characteristic curve of the battery voltage to be decomposed into a characteristic curve of the anode potential and a characteristic curve of the cathode potential. The characteristic chart showing relationships between the SOC and the anode/cathode potentials given as an example in FIG. 3 can be prepared by using the above-described technique of applying the differential analysis to the characteristic curve of the battery voltage. This characteristic chart can be determined by applying the differential analysis to test data preparatorily measured with a lithium-ion secondary battery before the battery is mounted on the electrical storage system.

While a battery is in use, various reactions progress inside the battery, where the internal state of the battery including anode/cathode potentials under an unchanged SOC varies. FIG. 4 shows an example of the characteristic chart showing relationships between the SOC and the anode/cathode potentials in a battery after use. The horizontal axis represents an SOC and the vertical axis represents a voltage or an electrode potential. An after-use SOC curve 401 is a curve showing a relationship between the SOC and the battery voltage after use. An after-use anode SOC curve 402 and an after-use cathode SOC curve 403 are curves showing relationships between the SOC and the anode/cathode potentials, respectively, in the initial stage. A result of subtracting the after-use cathode SOC curve 403 from the after-use anode SOC curve 402 is the after-use SOC curve 401.

The characteristic chart showing the relationships between the SOC and the anode/cathode potentials in the after-use battery is prepared by using the technique of applying differential analysis to the characteristic curve of the battery voltage of the after-use battery, the characteristic chart being given as an example in FIG. 4. This characteristic chart can be determined by, for example, executing a discharge measurement with a fine current in a regular maintenance of the electrical storage system and then applying the differential analysis to the measurement result. The discharge measurement by the fine current may be fulfilled by executing a discharge test in such a fashion that a voltage per cell falls upon an operating voltage of 4.2 V to 2.7 V at 0.01 C to 0.02 C as an example, where 1 C is equivalent to a current value resulting from one-hour discharge of nominal capacity.

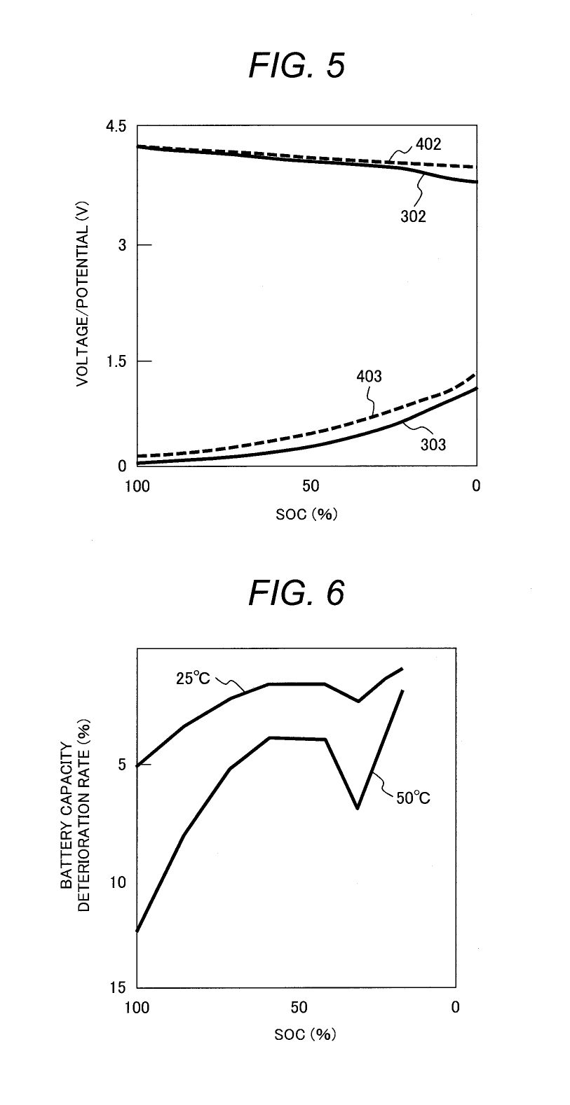

FIG. 5 shows a characteristic chart in which the relationships between the SOC and the anode/cathode potentials in the initial state and the after-use state of the battery given as the example (FIGS. 3 and 4) are compared with each other. Since the battery, when continued to be used, yield progress of various reactions inside the battery, involving variations in the internal state of the battery, the initial anode SOC curve 302 and the initial cathode SOC curve 303, differing from the after-use anode SOC curve 402 and the after-use cathode SOC curve 403, yield variations in the anode potential and the cathode potential at individual SOCs.

On condition that the initial anode SOC curve 302 and the initial cathode SOC curve 303 used for a control process before maintenance are changed over to the after-use anode SOC curve 402 and the after-use cathode SOC curve 403 after the maintenance, it becomes implementable to calculate more accurate anode/cathode potentials dependent on the internal state of the battery. As a result, an excessive operation of the cooling means is suppressed, so that a proper temperature management control can be achieved. Particularly in the initial use of the battery, since larger variations in the relationship between the SOC and the anode/cathode potentials are involved, increasing the frequency of data-updating maintenance makes it implementable to calculate more accurate potentials of the anode and the cathode from the SOCs.

For operation of the temperature control device from the anode potential and the cathode potential calculated from the SOC, there is a need for a relationship among temperature, anode potential and cathode potential for operating the temperature control device.

FIG. 6 shows an example of the characteristic chart showing relationships between the SOC and a battery deterioration of a battery. This characteristic chart is a chart obtained from calculating the battery deteriorations when batteries charged to individual SOCs are stored at various temperatures. FIG. 6 gives an example in which a battery capacity deterioration rate serving as an index of the battery deterioration is shown at 25° C. and 50° C. The horizontal axis represents the SOC and the vertical axis represents the battery capacity deterioration rate. Herein, the battery capacity deterioration rate is an index showing a deterioration degree of the battery and is expressed by a percentage calculated by dividing a decreased amount of the battery capacity by the battery capacity measured in an initial stage, the decreased amount of the battery capacity being a value of the battery capacity decreased from a time when the battery capacity has measured in the initial stage.

As can be seen from FIG. 6, the battery deterioration at higher temperatures is noticeable, whereas the battery deterioration at lower temperatures is relatively mild. It can also be seen that the battery deterioration depends on the SOC. In more detail, the battery deterioration depends on the anode potential and the cathode potential at the individual SOCs. For the anode potential and the cathode potential, there exist potential levels, respectively, that greatly contribute to the battery deterioration. There may be difference between the SOC of the battery that leads to the anode potential contributing to the deterioration and the SOC of the battery that leads to the cathode potential contributing to the deterioration. For this reason, the SOC and the battery deterioration may be in a relation other than a simple incremental relation, as shown in FIG. 6.

From the result of FIG. 6, it has proved through analysis of the anode and the cathode that battery deterioration at the SOC of about 30% depends on the anode potential while the battery deterioration at higher SOCs depends on the cathode potential. From these results, the battery temperatures at which the deterioration starts to be notably accelerated in the anode potential and the cathode potential, respectively, are calculated. Based on its result, temperatures at which the temperature control device is to be operated in the anode potential and the cathode potential are determined. Hereinafter, the temperature at which the temperature control device is to be operated corresponding to the anode potential is referred to as “an anode restriction temperature”, and the temperature at which the temperature control device is to be operated corresponding to the cathode potential is referred to as “a cathode restriction temperature”.

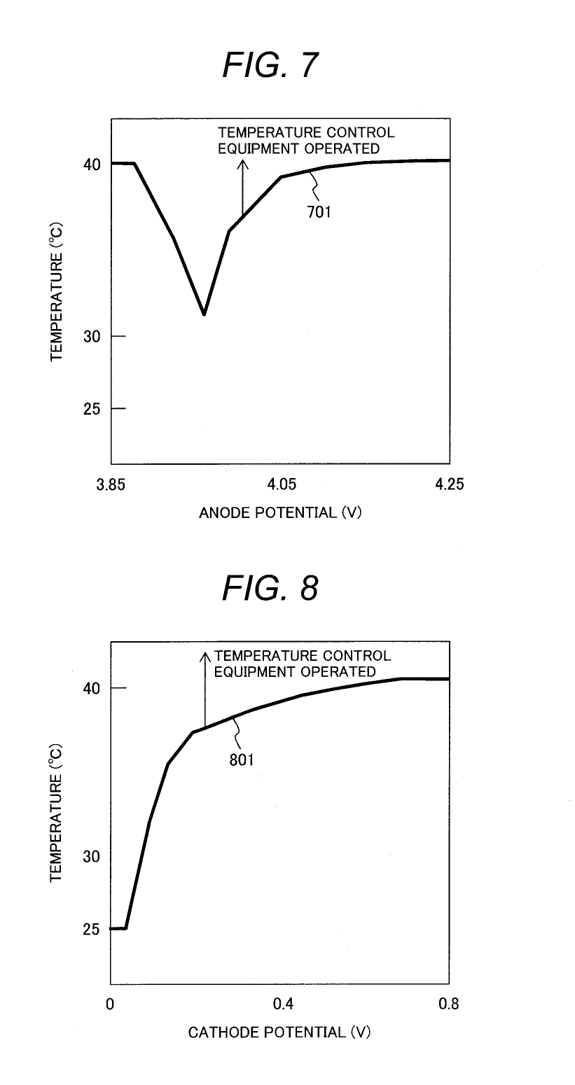

FIG. 7 is a characteristic chart showing a relationship between the battery temperature for operating the temperature control device and the anode potential. The horizontal axis represents the anode potential and the vertical axis represents temperature. An anode restriction temperature 701 shows a relationship between the temperature for operating the temperature control device and the anode potential, where the temperature control device is to be operated when a temperature of the anode restriction temperature 701 is exceeded.

FIG. 8 is a characteristic chart showing a relationship between the battery temperature for operating the temperature control device and the cathode potential. The horizontal axis represents the cathode potential and the vertical axis represents temperature. A cathode restriction temperature 801 shows a relationship between the temperature for operating the temperature control device and the cathode potential, where the temperature control device is to be operated when a temperature of the cathode restriction temperature 801 is exceeded.

By operating the temperature control device based on such anode/cathode temperature restriction curves as in FIGS. 7 and 8, it becomes implementable to operate a cooling system preferentially when the anode/cathode potential falls within a deterioration-accelerated range, so that the operating cost can be reduced. Thus, on condition that the relationship between the anode/cathode potentials and the temperature for operating the temperature control device, which are calculated from the relationship between SOC and battery deterioration, is preparatorily incorporated into the battery management unit 100, it becomes implementable to fulfill a temperature control that reflects the internal state of the battery.

The results of FIGS. 6 to 8 are only examples and those results vary depending on materials used for the anode active material and the cathode active material. On condition that a relationship between the restrictive temperature and the anode/cathode potentials is preparatorily built up by specifically determining a deterioration main factor of the secondary battery and verifying whether the deterioration is due to the anode or the cathode, the relationships can be applied to batteries in which the material used for the anode active material and the material used for the cathode active material differ from each other.

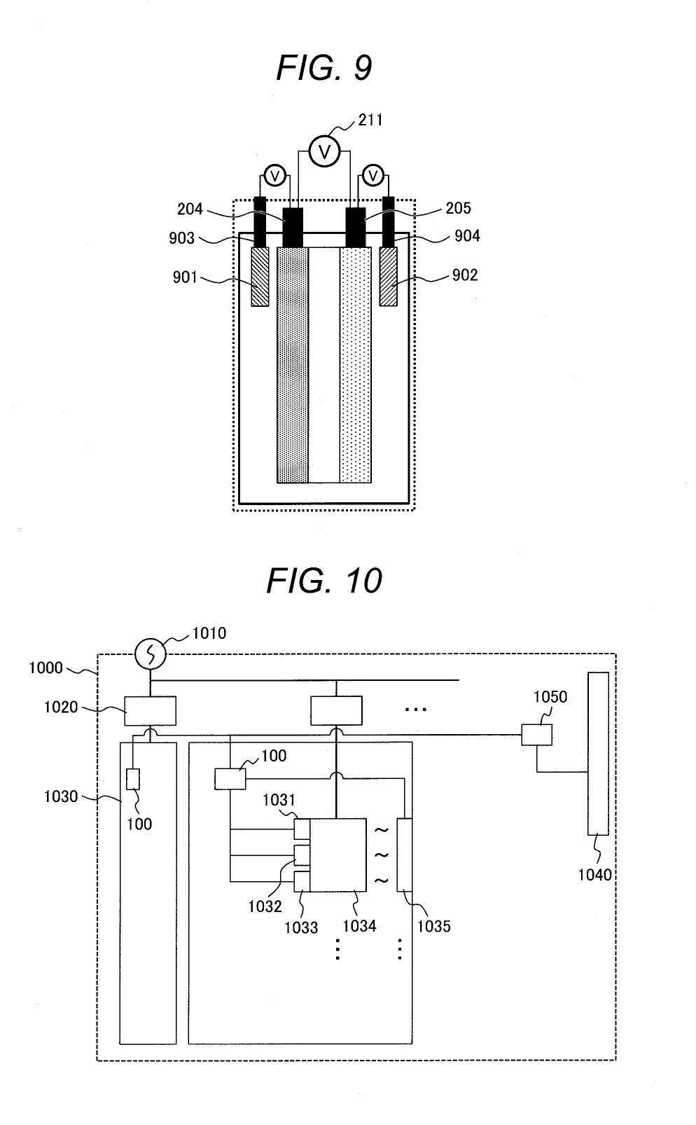

As a method for detecting the anode potential and the cathode potential, reference electrodes for use of a potential measurement that do not contribute to reaction may be set in the lithium-ion secondary battery. FIG. 9 is a schematic view of a lithium-ion secondary battery in which an anode reference electrode 901 and a cathode reference electrode 902 for measurement of an anode potential and an cathode potential are set in the lithium-ion secondary battery, as one embodiment.

Connecting the anode terminal 204, an anode reference electrode terminal 903 and the voltage sensor 211 allows the anode potential to be detected. Connecting the cathode terminal 205, a cathode reference electrode terminal 904 and the voltage sensor 211 allows the cathode potential to be detected.

Use of the battery of FIG. 9 makes it possible to achieve more accurate detection of the anode potential and the cathode potential without splitting the anode potential and the cathode potential by the differential analysis technique during maintenance periods. As a result, it becomes implementable to fulfill a high precision control. On the other hand, as compared with the case where the anode/cathode potentials are detected from the SOCs, the load of the battery fabrication process becomes higher so that the fabrication cost becomes higher. Although the lithium-ion secondary battery in which two kinds of reference electrodes, the anode reference electrode 901 and the cathode reference electrode 902 are set up is illustrated as an example above, the reference electrode does not need to be provided in two kinds.

As to these results, the control method will be described with reference to the following embodiment.

### Embodiment

FIG. 10 is a block diagram of an electrical storage system 1000 (a secondary battery system) according to one embodiment of the present invention, where a stationary storage system is assumed. The electrical storage system 1000 is systematically interconnected with external circuits via a connecting part 1010. It is designed that an alternating-current wave flowing up from the connecting part 1010 is converted to a direct current by a power conditioner 1020 so that a direct current flows through a battery panel 1030. In the battery panel 1030, cell modules 1034 each made up of series cells are arrayed in series and parallel. Cell temperature, cell voltage and flowing-current value in each cell in the cell modules 1034 are detected by a temperature sensor 1031, a voltage sensor 1032 and a current sensor 1033, respectively, and then transmitted to the battery management unit 100. The battery management unit 100 analyzes the cell temperature, the cell voltage and the current value which are detected and transmits a signal which is obtained based on the analysis result to a fan 1035 to operate the system. Also, a master battery management unit 1050 which administers battery management units 100 in each battery panel 1030 transmits a signal to an air conditioner 1040 to operate the system.

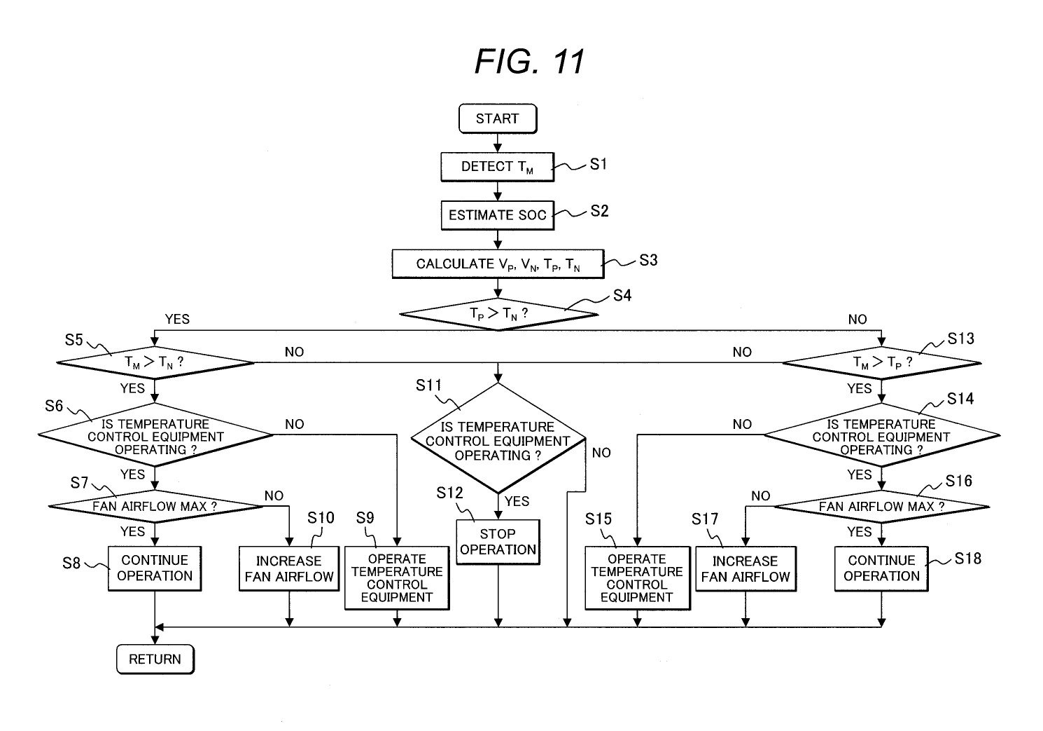

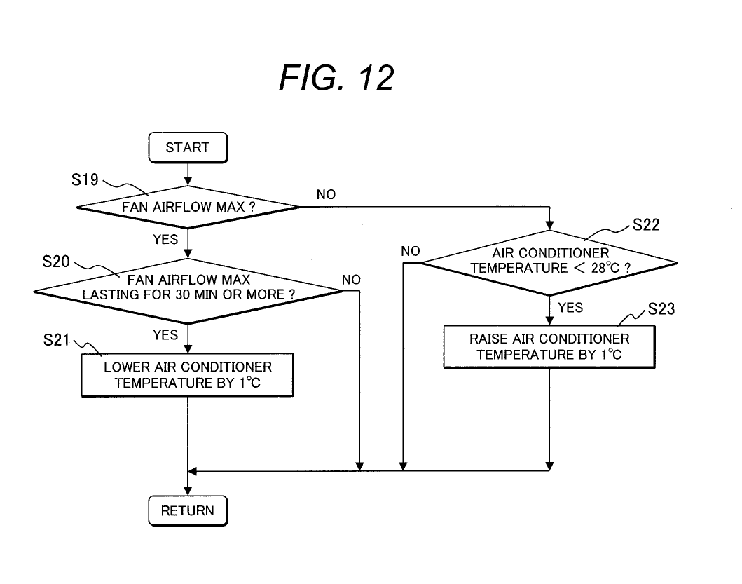

FIGS. 11 and 12 are flowcharts for explaining a control process to operate the temperature control device in the electrical storage system of FIG. 10. It is noted that process steps shown in these control flowcharts are called up from the main routine and executed at constant time intervals.

The lithium-ion secondary battery is subject to progress of a battery deterioration due to a temperature rise caused by a heat generation of the battery or an anode potential and a cathode potential during its operation. Therefore, in the flowcharts of FIGS. 11 and 12, the temperature control device is operated by using an estimated SOC as well as an initial anode SOC curve 302, an initial cathode SOC curve 303, an anode restriction temperature 701 and a cathode restriction temperature 801 which are previously extracted. Thereby, both an elongated serve life of the battery and a cost reduction of a cooling operation can be satisfied at the same time.

Also, on condition that the after-use anode SOC curve 402 and the after-use cathode SOC curve 403 are calculated after maintenance, operating the temperature control device by using the after-use anode SOC curve 402, the after-use cathode SOC curve 403, the anode restriction temperature 701 and the cathode restriction temperature 801 in the flowchart of FIG. 11 makes it possible to suppress an excessive operation of the cooling device so that the elongated serve life of the battery and the cost reduction of the cooling operation can be satisfied at the same time.

The control flowchart of FIG. 11 will be described.

### <Step S1>

Individual cell temperatures of the cell modules 1034 detected by the temperature sensors 1031 are transmitted to the battery management unit 100, where a battery maximum temperature T_{M} is detected. The process is moved to step S2.

### <Step S2>

Resultant voltages and current values of the individual cells of the cell modules 1034 transmitted from the voltage sensors 1032 and the current sensors 1033 are analyzed by the battery management unit 100, so that an SOC of the battery is estimated and outputted. The process is moved to step S3.

### <Step S3>

An anode potential V_{P} and a cathode potential V_{N} are calculated by using an outputted estimated SOC, the initial anode SOC curve 302 and the initial cathode SOC curve 303. Next, from the outputted anode potential V_{P} and cathode potential V_{N}, an anode restrictive temperature T_{P} and a cathode restrictive temperature T_{H} are calculated by using the anode restriction temperature 701 and the cathode restriction temperature 801. The process is moved to step S4.

### <Step S4>

The anode restrictive temperature T_{P} and the cathode restrictive temperature T_{N} are compared with each other, by which it is decided whether or not the anode restrictive temperature T_{P} is larger than the cathode restrictive temperature T_{N}. This is aimed at focusing control on the lower temperature out of the anode restrictive temperature T_{P} and the cathode restrictive temperature T_{N}. Then, if it is decided that the anode restrictive temperature T_{P} is larger than the cathode restrictive temperature T_{N} (YES at step S4), then the process is moved to step S5. If it is decided at step S4 that the anode restrictive temperature T_{P} is smaller than the cathode restrictive temperature T_{N} (NO at step S4), then the process is moved to step S13.

### <Step S5>

The battery maximum temperature T_{M} and the cathode restrictive temperature T_{N} are compared with each other, by which it is decided whether or not the battery maximum temperature T_{M} is larger than the cathode restrictive temperature T_{N}. If it is decided that the battery maximum temperature T_{M} is larger than the cathode restrictive temperature T_{N} (YES at step S5), then the process is moved to step S6. If it is decided at step S5 that the battery maximum temperature T_{M} is smaller than the cathode restrictive temperature T_{N} (NO at step S5), then the process is moved to step S7.

### <Step S6>

In the battery management unit 100, it is decided whether or not the temperature control equipment, i.e. the fan 1035, is operating. If it is decided that the temperature control equipment is operating (YES at step S6), then the process is moved to step S7. If it is decided at step S6 that the temperature control equipment is not operating (NO at step S6), then the process is moved to step S9.

### <Step S7>

In the battery management unit 100, it is decided whether or not airflow of the fan 1035 is at a maximum. If it is decided that the airflow of the fan 1035 is at a maximum (YES at step S7), then the process is moved to step S8. If it is decided at step S7 that the airflow of fan 1035 is not at a maximum (NO at step S7), then the process is moved to step S10.

### <Step S8>

The temperature control equipment, i.e. the fan 1035, is continued operating as it is. Thereafter, the process is returned to the start, where the process is restarted with step S1.

### <Step S9>

In the battery management unit 100, the temperature control equipment, i.e. the fan 1035, is operated at a small airflow. Thereafter, the process is returned to the start, where the process is restarted with step S1.

### <Step S10>

In the battery management unit 100, the airflow of the temperature control equipment, i.e. the fan 1035, is incremented by one level. Thereafter, the process is returned to the start, where the process is restarted with step S1.

### <Step S11>

In the battery management unit 100, it is decided whether or not the temperature control equipment, i.e. the fan 1035, is operating. If it is decided that the temperature control equipment is operating (YES at step S11), then the process is moved to step S12. If it is decided at step S11 that the temperature control equipment is not operating (NO at step S11), then the process is returned to the start, where the process is restarted with step S1.

### <Step S12>

In the battery management unit 100, the temperature control equipment, i.e. the fan 1035, is stopped from operating. Thereafter, the process is returned to the start, where the process is restarted with step S1.

### <Step S13>

The battery maximum temperature T_{M} and the anode restrictive temperature T_{P} are compared with each other, by which it is decided whether or not the battery maximum temperature T_{M} is larger than the anode restrictive temperature T_{P}. If it is decided that the battery maximum temperature T_{M} is larger than the anode restrictive temperature T_{P} (YES at step S13), then the process is moved to step S14. If it is decided at step S13 that the battery maximum temperature T_{M} is smaller than the anode restrictive temperature T_{P} (NO at step S13), then the process is moved to step S11.

### <Step S14>

In the battery management unit 100, it is decided whether or not the temperature control equipment, i.e. the fan 1035, is operating. If it is decided that the temperature control equipment is operating (YES at step S14), then the process is moved to step S16. If it is decided at step S14 that the temperature control equipment is not operating (NO at step S14), then the process is moved to step S15.

### <Step S15>

In the battery management unit 100, the temperature control equipment, i.e. the fan 1035, is operated at a small airflow. Thereafter, the process is returned to the start, where the process is restarted with step S1.

### <Step S16>

In the battery management unit 100, it is decided whether or not the airflow of the fan 1035 is at a maximum. If it is decided that the airflow of the fan 1035 is at a maximum (YES at step S16), then the process is moved to step S16. If it is decided at step S16 that the airflow of the fan 1035 is not at a maximum (NO at step S16), then the process is moved to step S17.

### <Step S17>

In the battery management unit 100, the airflow of the temperature control equipment, i.e. the fan 1035, is incremented by one level. Thereafter, the process is returned to the start, where the process is restarted with step S1.

### <Step S18>

The temperature control equipment, i.e. the fan 1035, is continued operating as it is. Thereafter, the process is returned to the start, where the process is restarted with step S1.

In the control along the flowchart of FIG. 11, the lower restrictive temperature out of the anode restrictive temperature and the cathode restrictive temperature is compared with the battery temperature. If the battery temperature is equal to or higher than the restrictive temperature, the temperature control device is operated; conversely, if the battery temperature is lower than the restrictive temperature, the temperature control device is stopped. As a result, at temperatures beyond the restrictive temperature, the secondary battery can be cooled, allowing the battery to be elongated in a service life. Also, since the restrictive temperatures in response to the anode/cathode potentials can be determined based on the internal state of the battery, the cooling system can be operated preferentially when the anode/cathode potentials fall within the battery deterioration-accelerated range, allowing the cooling-system operating cost to be reduced.

Next, the control flowchart of FIG. 12 will be described. The process steps shown in the flowchart of FIG. 12 are called up from the main routine and executed at constant time intervals. The process may also be started in linkage with step S7 or step S16 shown in the flowchart of FIG. 11.

### <Step S19>

In the battery management unit 100, it is decided whether or not the fan 1035 is operating at a maximum airflow. If it is decided that the fan is operating at a maximum airflow (YES at step S19), then the process is moved to step S20. If it is decided at step S19 that the fan is not operating at a maximum airflow (NO at step S19), then the process is moved to step S22.

### <Step S20>

In the battery management unit 100, a time duration for which the fan 1035 has been operating at a maximum airflow is outputted, where whether or not the time output is 30 minutes or more is decided. If it is decided whether or not the fan 1035 has been operating at a maximum airflow for 30 minutes or more (YES at step S20), the process is moved to step S21. If it is decided at step S20 that the fan 1035 has been operating at a maximum airflow for less than 30 minutes (NO at step S20), then the process is returned to the start, where the process is restarted with step S1.

### <Step S21>

In the master battery management unit 1050, the air-conditioning temperature of the air conditioner 1040 is decremented by 1° C. Thereafter, the process is returned to the start, where the process is restarted with step S1.

### <Step S22>

In the master battery management unit 1050, it is decided whether or not the air-conditioning temperature of the air conditioner 1040 is lower than 28° C. If it is decided that the air-conditioning temperature of the air conditioner is lower than 28° C. (YES at step S22), then the process is moved to step S23. If it is decided at step S22 that the air-conditioning temperature of the air conditioner is equal to or higher than 28° C. (NO at step S22), then the process is subsequently returned to the start, where the process is restarted with step S1.

### <Step S23>

In the master battery management unit 1050, the air-conditioning temperature of the air conditioner 1040 is incremented by 1° C. Thereafter, the process is returned to the start, where the process is restarted with step S1.

By the control along the flowchart of FIG. 12, such control can be fulfilled that the air-conditioning temperature is lowered when the temperature control device has been operating at a maximum airflow for more than a specified time duration. Thus, by controlling the fan airflow or the air-conditioning temperature in response to the battery temperature, the excessive cooling can be suppressed so that the operating cost can be reduced.

As described hereinabove, performing the control using the flowcharts of FIGS. 11 and 12 makes it possible to elongate the service life attributable to suppression of the battery deterioration. Also, it is implementable to reduce the operating cost by the arrangement that the operating temperature of the temperature control equipment is dependent on the anode potential and the cathode potential, where the temperature control equipment is stopped from operating at anode potentials and cathode potentials that do not incur noticeable battery deterioration.

1. A secondary battery system comprising:
a secondary battery having an anode and a cathode;
a temperature control device for cooling the secondary battery;
a battery management unit; and
a temperature detector for detecting a temperature of the secondary battery,
wherein the battery management unit includes an SOC calculating part for calculating a state of charge of the secondary battery and a potential estimating part for estimating potentials of the anode and the cathode of the secondary battery, and
wherein the temperature control device is operated when an operating condition is set corresponding to the potentials of the anode and the cathode is met.

2. The secondary battery system according to claim 1,
wherein the battery management unit includes a restriction temperature determining part for determining an anode restriction temperature corresponding to an estimated potential of the anode and a cathode restriction temperature corresponding to an estimated potential of the cathode on the basis of a relationship between a battery capacity deterioration rate and the state of charge, and
wherein the temperature control device is operated when a temperature detected by the temperature detector is equal to or higher than any one of the anode restriction temperature and the cathode restriction temperature, and the temperature control device is stopped when a temperature detected by the temperature detector is lower than the anode restriction temperature and the cathode restriction temperature.

3. The secondary battery system according to claim 2, further comprising:
a current detector for detecting a current value; and
a voltage detector for detecting a voltage value,
wherein the SOC calculating part calculates the state of charge from a current value detected by the current detector and a voltage value detected by the voltage detector, and
wherein the potential estimating part estimates the potentials of the anode and the cathode from a calculated state of charge and a preparatorily stored relationship between the states of charge and the potentials of the anode and the cathode.

4. The secondary battery system according to claim 3,
wherein the relationship between the states of charge and the potentials of the anode and the cathode stored in the potential estimating part can be updated by executing discharge measurement of the secondary battery in regular system maintenance and by using a result of the discharge measurement subjected to differential analysis.

5. The secondary battery system according to claim 2,
wherein the secondary battery has a reference electrode, and
wherein the potential estimating part detects the potentials of the anode and the cathode by the reference electrode.

6. The secondary battery system according to claim 1,
wherein the temperature control device controls the temperature of the secondary battery by adjusting an airflow and an air-conditioning temperature.

7. The secondary battery system according to claim 6, wherein the temperature control device controls an air conditioner so as to lower the air-conditioning temperature when the airflow is operated at a maximum for more than a specified time duration.
